(19) United States
(12) Patent Application Publication
(10) Pub. No.: US 2010/0256250 A1
(43) Pub. Date: Oct. 7, 2010

(54) POLYURETHANE FOAM FOR THERMAL INSULATION AT EXTREMELY LOW TEMPERATURES

(76) Inventors: Jörg Krüger, Weyhe (DE); Mark Müller, Bremen (DE); Vladimir YAKUSHIN, Riga (LV); Ugis CABULIS, Riga (LV); Uldis STIRNA, Riga (LV)

Correspondence Address: NILS H. LJUNGMAN & ASSOCIATES, P. O. BOX 130, GREENSBURG, PA, 15601-0130, US

(21) Appl. No.: 12/752,514

(22) Filed: Apr. 1, 2010

(30) Foreign Application Priority Data
Apr. 1, 2009 (DE) 10 2009 016 632.7

(51) Int. Cl. C08G 18/48; C08G 18/32

(52) U.S. Cl. 521/164; 521/170; 521/174

(57) ABSTRACT

A polyurethane foam for thermal insulation at extremely low temperatures. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

Background information is for informational purposes only and does not necessarily admit that subsequently mentioned information and publications are prior art.

1. Technical Field

The present application relates to a polyurethane foam for thermal insulation at extremely low temperatures which is produced by a reaction of polyisocyanate and polyols that comprise at least two active hydrogen atoms, a chain extender, a blowing agent, a foam stabilizer and catalysts. The present application further relates to a use of a polyurethane foam of this type.

2. Background Information

For the storage of liquefied gases such as methane, liquefied natural gas (LNG) and liquid hydrogen (LH₂) and their transport, an effective thermal insulation is desired in tanks and containers that are manufactured in a wide variety of different designs. Polyurethane foams (PER foams) or polyisocyanurate foams (PIR foams) are most frequently used for the thermal insulation of tanks for the storage and transport of liquefied gas. In general, there are two different methods for the insulation of liquefied gas tanks. In the first method, the insulating material is deposited on the exterior of the wall of the tank, and in the second method the insulating material is instead deposited on the interior of the wall of the tank. In both cases, thermal stresses occur in the insulation material as soon as the tank is filled with the liquefied gas. The reason for these thermal stresses during the filling and emptying of the tank lies in the fact that the coefficient of thermal expansion of the insulation material and the coefficient of thermal expansion of the wall material of the tank, which is usually a metal, are different. The resulting thermal stresses can therefore cause deformations of the thermally insulating materials which in turn lead to the formation of cracks.

The cryo-fluids are also often transported and/or stored at pressures that are greater than the ambient atmospheric pressure. Leak tests, which are also called proof tests, are often performed on tanks of this type under ambient conditions, in which case typical values for aerospace applications are four to eight bar. Therefore the low-temperature interior insulation may also have a high compressive strength in relation to thermal stresses in the low-temperature range both at low temperatures and at ambient temperatures.

For applications in aerospace technology, liquid hydrogen is generally used as a propellant in modern high-power thrusters and may be transported in large (mostly metal) tanks. Under these conditions, loads occur in challenging combinations that may make certain properties of an insulation or an insulation material desirable. These properties include a high compressive strength both at room temperature, e.g. during acceptance tests, as well as low temperatures and a high resistance to thermal expansion and contraction (comprising the ratio of elongation at failure to thermal deformation ε₇₇/ΔI₍₂₉₆₋₇₇₎ to minimize cracking, i.e. the loss of the insulating effect and the generation of particle contamination in the fuel). A high insulating effect is also desired with low thermal conductivity λ at a minimum mass and density.

A combination of properties of this type cannot be found among some technologies. In general, of course, in contrast to conventional polyurethane foams, the thermal tensile stresses in polyurethane foams that are specially designed for use as low-temperature insulation are significantly lower at low temperatures than their tensile or tear strength at a temperature of seventy-seven kelvins or twenty kelvins. Therefore it is also relatively unlikely that deformations will occur in these materials under operating conditions that might lead to the formation of cracks in the foam. This is due to the fact that these materials have a higher tear strength at and a higher elongation at failure E than conventional PUR foams at a temperature of seventy-seven kelvins or twenty kelvins.

However, with PUR foams which are specially designed for use as low-temperature external insulation, the compressive strength ac is generally not sufficient to also make them suitable for use as low-temperature internal insulation in tanks. For this reason, the PUR or PIR foams that have previously been suggested for use as external low-temperature insulation generally do not meet the desired qualities indicated above. Instead, these PUR foams are primarily those that are provided for the insulation of natural gas and liquid nitrogen (LN₂) storage tanks.

For example, some polyurethane foams for thermal insulation in the extreme low-temperature range have a method for producing polyurethane foam, wherein a mixture of propoxylated/ethoxylated sorbitol, pentaerythritrol, saccharose, phthalic anhydride and bisphenol-A derivatives are reacted with 4,4′ diphenylmethane diisocyanate polymer in the presence of blowing agents, catalysts, stabilizers and other additives. In this method, the mixture is produced from a mixture of twenty to sixty weight percent propoxylated/ethoxylated sorbitol, ten to forty weight percent propoxylated/ethoxylated pentaerythritol, ten to twenty weight percent propoxylated/ethoxylated saccharose, ten to twenty weight percent propoxylated/ethoxylated phthalic anhydride and ten to twenty weight percent propoxylated/ethoxylated bisphenol A as well as a 4,4′ diphenylmethane diisocyanate polymer with 2.7 to 3.1 functional groups per molecule, and is recommended for use as insulation for natural gas tanks. This foam comprises a high compressive strength of approximately 0.8 megapascal at room temperature and a density of ninety kilograms per cubic meter, although it seems questionable whether this material also has the desired resistance to thermal tensile stresses when it is used with liquid hydrogen.

The same is true for some other foams. For example, some PUR foams are intended for the insulation of natural gas and liquid nitrogen storage tanks.

### OBJECT OR OBJECTS

An object of the present application is to make available a polyurethane foam of the type described above which makes possible the use of the material produced according to this method as low-temperature internal insulation of tanks for the transport and storage of cryo-fluids, whereby, in at least one embodiment of the present application, these fluids are primarily but not exclusively liquid hydrogen (LH₂). The macroscopic properties of the polyurethane foam produced according to this method may comprise the desired qualities described above. In at least one possible embodiment, the foam may have a high resistance to deformations that can occur as a result of thermal stresses during the filling of the tank with liquid hydrogen, a high elongation at failure under tensile loads, a high compressive strength and also the lowest possible density both at ambient temperatures and at seventy-seven kelvins.

### SUMMARY

The present application teaches that this object is accomplished with a polyurethane foam of the type described above in which the proportion of urethane, ester and aromatic rings in the polymer matrix is between seventy and eighty-five percent by weight and that the molecular weight per branching unit is between five hundred and seven hundred.

In at least one possible embodiment of the method disclosed by the present application, the following ingredients are present: polyether polyol which is produced by polyaddition of propylene oxide and ethylene oxide to sorbitol or saccharose;

chain extenders, for example C4 to C6 alkane diol or also diethylene glycol or dipropylene glycol or an N-substituted diethanol amine, N-methyl diethanol amine, N-ethyldiethanol amine or N-phenyl diethanol amine; and

polyester polyols with aromatic structure.

The introduction of polyether polyols hereby increases the compressive strength, and on the other hand the use of bifunctional polyester polyols promotes high elongation-at-failure characteristics. In at least one possible embodiment of the method for the production of the polyurethane foam disclosed by the present application, a blowing agent with an ozonolysis potential (OAP) of zero is used, and as catalysts either tertiary amines alone or in the form of a mixture with a tin catalyst.

As a result, it thereby becomes possible to produce a polyurethane foam disclosed by the present application having the following characteristics:

a density in the range of sixty-five to one hundred and ten kilograms per cubic meter, in at least one possible embodiment, seventy to ninety kilograms per cubic meter;

a ratio ε₇₇/ΔI₍₂₉₆₋₇₇₎ vertical, substantially vertical, or essentially vertical to the foaming direction in the range of 3.5 to five; and

a compressive strength parallel, substantially parallel, virtually parallel, or essentially parallel to the foaming direction in the range of 0.65 to 0.90 megapascal at two hundred and ninety-six kelvins, and 1.5 to 2.1 megapascals at seventy-seven kelvins.

For the internal insulation of tanks by means of a polyurethane foam of the type described above for the storage of cryogenic fluids, this foam is applied by means of cast molding and spraying technologies, whereby this method can be used both for the installation of reinforced and non-reinforced flat or curved structures. The polyurethane foam disclosed by the present application can also be combined, for example to meet purity requirements, both with a low-temperature epoxy lining as well as with an epoxy-based undercoat for the improvement of the adhesive strength.

The insulation achieved with the polyurethane foam disclosed by the present application is resistant to thermal loads and deformations caused by low temperatures and has a high compressive strength. This polyurethane foam of the present application comprises a combination of the characteristics. The polyurethane foam of the present application may be used on the interior wall of tanks which are wetted with a cryo-fluid. This polyurethane foam also has a high compressive strength both at room temperature as well as in the low temperature range with a relatively low density. The polyurethane foam of the present application also has the desired insulation properties of polyurethane hard foams. Further, this polyurethane foam has a high resistance to thermal stresses. Also in the case of the polyurethane foam of the present application, particulate impurities may be reduced by an additional epoxy coating. This polyurethane foam insulation can also be applied to both reinforced and non-reinforced structures. The polyurethane foam of the present application may also be applied on both flat and curved surfaces.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows Table 1 containing the composition, polymer matrix parameters and technological parameters of seven different examples of polyurethane foam;

FIG. 2 shows Table 2 containing the compression and tensile characteristics of the polyurethane foams listed in Table 1 at different temperatures; and

FIG. 3 shows initial measured values for the thermal conductivity of polyurethane foam example 5 in Tables 1 and 2.

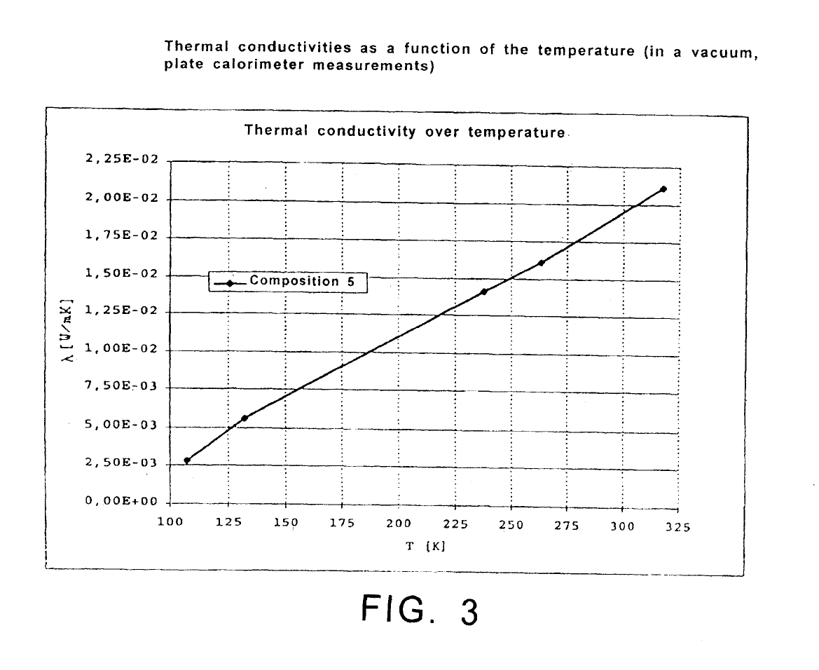

### DESCRIPTION OF EMBODIMENT OR EMBODIMENTS

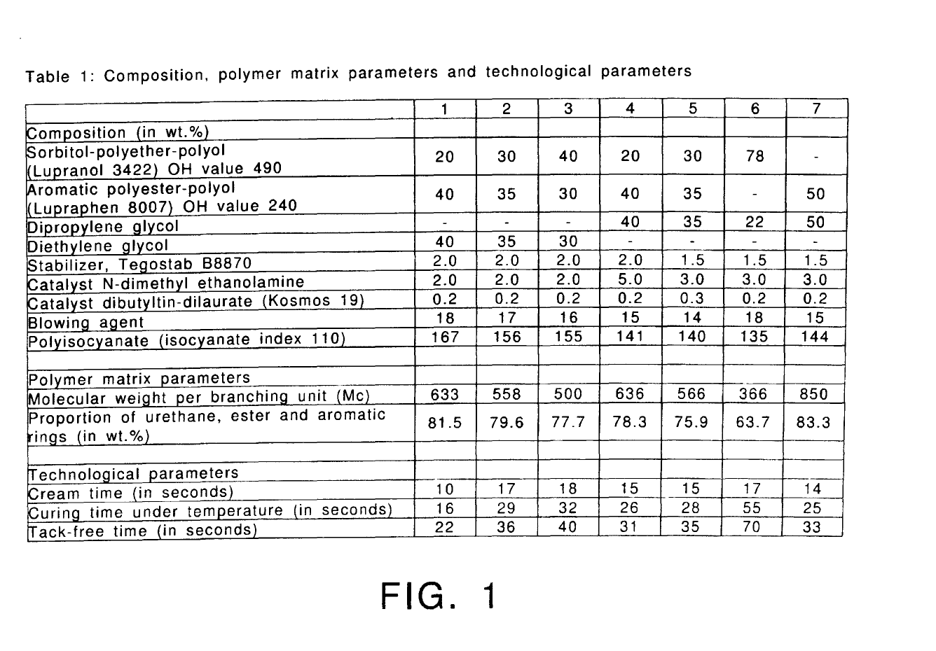

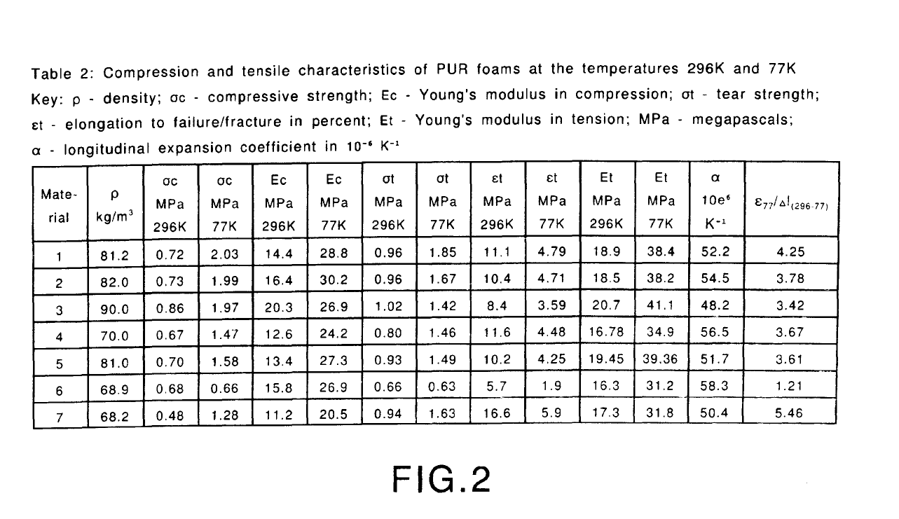

The production of polyurethane foams disclosed by the present application is described in greater detail on the basis of examples. The composition, polymer matrix parameters and technological parameters of different polyurethane foams disclosed by the present application are summarized in Table 1 (FIG. 1), while Table 2 (FIG. 2) indicates the compression and tensile characteristics of the PUR foams listed in Table 1 at the temperatures two hundred and ninety-six kelvins and seventy-seven kelvins.

The production of a typical polyurethane foam composition is also described below on the basis of an Example 1.

### EXAMPLE 1

### Component A

Sorbitol polyether polyol

Aromatic polyester polyol

Diethylene glycol

Catalysts

Blowing agent

### Component B

Polyisocyanate

Table 1 shows the amounts of the above materials in weight percent (wt. %), and should be read as follows. In Example 1, the first three materials are sorbitol-polyether-polyol 20 wt. %, aromatic polyester-polyol 40 wt. %, and diethylene glycol 40 wt. %. These three materials form 100% of a certain weight. The stabilizer Tegostab B8870 is provided in a quantity that is 2 wt. % of that certain weight, i.e. the weight of the first three materials. Similarly, catalyst N-dimethyl ethanolamine is provided in a quantity that is 2 wt. % of that certain weight, catalyst dibutyltin-dilaurate is provided in a quantity that is 0.2 wt. % of that certain weight, and a blowing agent is provided in a quantity that is 18 wt. % of that certain weight. All of these materials, as described above, form “Component A.” Also described above is a “Component B,” which is polyisocyanate. “Component B” is provided in an amount that is 167 wt. % of the weight of “Component A.” In other words, the amount of polyisocyanate is 67% by weight greater than the combined, total weight of all of the other materials, that is, sorbitol-polyether-polyol, aromatic polyester-polyol, diethylene glycol, stabilizer Tegostab B8870, catalyst N-dimethyl ethanolamine, catalyst dibutyltin-dilaurate, and the blowing agent. The other polyurethane foam Examples 2 through 7 should be read similarly in Table 1. It should also be noted that the “isocyanate index 110” mentioned in Table 1 is the amount of isocyanate used relative to the theoretical equivalent amount:

Isocyanate Index=(Actual amount of isocyanate used/Theoretical amount of iscoyanate required)×100.

The ingredients in Component A were first homogenized at 2800 rotations per minute with an agitator and then polyisocyanate (Component B) was added. This mixture was homogenized for seven seconds and then poured into a sheet mold. The following technological parameters were measured on the PUR foam thus obtained: a cream time of ten seconds, a curing time under temperature of sixteen seconds, and a tack-free time of twenty-two seconds. A PUR foam with a microporous structure was obtained, the mechanical characteristics of which are described in Table 2 (Example 1).

Two criteria can be used for the evaluation of PUR foams to describe the extent to which the PUR foams exhibit the qualities that are desired for the low-temperature internal insulation of storage and transport tanks. These criteria are, on the one hand, the ability of the PUR foams to minimize cracking under the action of deforming factors that can occur in the low temperature insulation of tanks as a result of thermal stresses. On the other hand, a second criterion that may be taken into consideration is a high compressive strength of the PUR foams at ambient temperature. The satisfaction of the first criterion by the PUR foam insulation, namely the minimization of cracking by deforming forces as a result of deforming forces caused by thermal stresses in the PUR foam, can be described by the following ratio, ε₇₇/ΔI₍₂₉₆₋₇₇₎ (1). In this ratio, Δ₇₇ is the elongation at failure of the PUR foam (in percent) in the vertical foaming direction at seventy-seven kelvins, and ΔI₍₂₉₆₋₇₇₎ is the contraction of the PUR foam (in percent) in the vertical foaming direction during cooling from two hundred and ninety-six kelvins to seventy-seven kelvins.

The ratio (1) indicates the factor by which the elongation at failure of the PUR foam at seventy-seven kelvins is greater than the deformations that occur as a result of the contraction of the PUR foam during cooling from two hundred and ninety-six kelvins to seventy-seven kelvins. The higher the ratio according to (1), the higher the probability that there will be no cracking in the thermal insulation material as a result of thermal stresses. To achieve sufficient protection of the PUR foams against the formation of cracks as a result of thermal stresses, the ratio ε₇₇/ΔI₍₂₉₆₋₇₇₎ may be no less than three. One possibility to achieve an index on this level is to manufacture PUR foams with a high ε₇₇ index.

The stress-strain characteristics of PUR foams are primarily a function of their polymer matrix parameters, i.e. of the molecular weight per branching unit (Mc) and the content of urethane, ester and aromatic rings. The elongation at failure index e of a PUR foam is essentially a function of its polymer matrix value Mc. Polymer matrix values Mc for conventional hard PUR foams are usually in the range of three hundred to five hundred, while the content of urethane, ester and aromatic rings in these foams is less than seventy weight percent. In connection with the polyurethane foam disclosed by the present application, however, it has now been found that, with a high percentage of urethane, ester and aromatic rings in the polymer matrix (seventy to eighty-five weight percent), PUR foams with relatively high Mc values of five hundred to seven hundred at seventy-seven kelvins comprise a high elongation at failure at seventy-seven kelvins, while also comprising a high compressive strength, which is demonstrated by the Examples 1 to 5 in the accompanying Table 1.

At Mc values of eight hundred to nine hundred, PUR foams have a high ratio ε₇₇/ΔI₍₂₉₆₋₇₇₎, although their compressive strength is not high, as demonstrated by Example 7 in Table 1.

PUR foams with a polymer matrix value Mc of approximately three hundred and sixty, of the type presented in Table 6, have a high compressive strength at ambient temperature, while their ε₇₇ value is very low. Therefore they are unsuitable for use as low-temperature internal isolation of liquid hydrogen tanks.

In at least one possible embodiment, the polyol mixture, that is, the mixture of the polyether polyol, the polyester polyol, and the chain extenders (glycols), may comprise 15 to 45 wt. %, or possibly 10 to 60 wt. %, of a polyether polyol with an OH value of approximately 490 mg KOH/g or an OH value in the range of between 450 and 530 mg KOH/g with a functionality of 2.0 or approximately 2.0 or possibly in the range of between 1.0 and 3.0; 15 to 45 wt. %, or possibly 10 to 60 wt. %, of a chain extender with the functionality 2.0; and 25 to 45 wt. %, or possibly 10 to 60 wt. %, of an aromatic structure polyester polyol with an OH value of approximately 240 mg KOH/g or an OH value in the range of between 200 and 280 mg KOH/g with a functionality of 2.0 or approximately 2.0 or possibly in the range of between 1.0 and 3.0. The sum of these components totals 100 wt. % of the polyol mixture. Please note that the ranges of wt. %, OH values, and functionality value disclosed herein should be understood as including all numbers of the range in whole numbers or in tenths, such as, for example, 15.0 wt. %, 15.1 wt. %, 15.2 wt. % . . . 44.8 wt. %, 44.9 wt. %, and 45.0 wt. %.

The present application relates to a polyurethane foam for thermal insulation at extremely low temperatures which is manufactured by a reaction of polyisocyanate and polyols that comprises at least two active hydrogen atoms, a chain extender, a blowing agent, a foam stabilizer and catalysts, whereby the proportion of urethane, ester and aromatic rings in the polymer matrix of the polyurethane foam is between seventy and eighty-five weight percent and the molecular weight per branching unit is between five hundred and seven hundred. The following ingredients are also provided:

polyether polyol, which is produced by polyaddition of propylene oxide and ethylene oxide to sorbitol or saccharose;

chain extenders, for example C4 to C6 alkane diols or also diethylene glycol or dipropylene glycol or an N-substituted diethanolamine, N-methyl diethanolamine, N-ethyl diethanolamine or N-phenyl diethanolamine; and

polyester polyols with aromatic structure.

For the interior insulation of tanks for the storage of cryogenic fluids, this polyurethane foam is applied for the insulation of both reinforced and non-reinforced flat or curved surfaces by means of casting or spray technologies. The polyurethane foam can also be combined with a low-temperature epoxy lining or with an epoxy base coat for the improvement of the adhesive strength.

One feature or aspect of an embodiment is believed at the time of the filing of this patent application to possibly reside broadly in a polyurethane foam for thermal insulation at extremely low temperatures, produced by a reaction of polyisocyanate and polyols which comprise at least two active hydrogen atoms, a chain extender, a blowing agent, a foam stabilizer and catalysts, wherein the proportion of urethane, ester and aromatic rings in the polymer matrix of the polyurethane foam is between seventy and eighty-five weight percent and that the molecular weight per branching unit is between five hundred and seven hundred.

Another feature or aspect of an embodiment is believed at the time of the filing of this patent application to possibly reside broadly in the polyurethane foam, wherein the polyol mixture comprises the following:

a) a polyether polyol;

b) 15 to 45 wt. % of a chain extender with the functionality 2.0;

c) 25 to 45 wt. % of an aromatic structure polyester polyol with an OH value between 200 and 280 mg KOH/g with the functionality 2.0, whereby the sum of the components from a), b) and c) is 100 wt. %.

Yet another feature or aspect of an embodiment is believed at the time of the filing of this patent application to possibly reside broadly in the polyurethane foam as, wherein the chain extender comprises C4 to C6 alkanediol, 1,4-butanediol, 2,3-butanediol, 1,5-pentanediol or 1,6-hexanediol.

Still another feature or aspect of an embodiment is believed at the time of the filing of this patent application to possibly reside broadly in the polyurethane foam, wherein the chain extender comprises diethylene glycol or dipropylene glycol.

A further feature or aspect of an embodiment is believed at the time of the filing of this patent application to possibly reside broadly in the polyurethane foam, wherein the chain extender is an N-substituted diethanol amine: N-methyldiethanol amine, N-ethyldiethanol amine or N-phenyl diethanolamine.

Another feature or aspect of an embodiment is believed at the time of the filing of this patent application to possibly reside broadly in the polyurethane foam, wherein the OH value is between five hundred and seven hundred and fifty.

Yet another feature or aspect of an embodiment is believed at the time of the filing of this patent application to possibly reside broadly in the polyurethane foam, wherein the functionality of the basic polyisocyanate is between 2.1 and 2.9.

Still another feature or aspect of an embodiment is believed at the time of the filing of this patent application to possibly reside broadly in the polyurethane foam, wherein it is produced by a casting or spraying method and its density is in the range of sixty-five to one hundred and ten kilograms per cubic meter, in at least one possible embodiment of the present application, seventy to ninety kilograms per cubic meter, the ratio ε₇₇/ΔI₍₂₉₆₋₇₇₎ of the elongation at failure in the vertical foaming direction at seventy-seven kelvins, ε₇₇, to the contraction in the vertical foaming direction during cooling from two hundred and ninety-six kelvins to seventy-seven kelvins, ΔI₍₂₉₆₋₇₇₎, perpendicular, virtually perpendicular, substantially perpendicular, or essentially perpendicular to the foaming direction in the range of 3.5 to five and that its compressive strength parallel, virtually parallel, substantially parallel, or essentially parallel to the foaming direction is in the range of 0.65 to 0.90 megapascal at two hundred and ninety-six kelvins and 1.5 to 2.1 megapascals at seventy-seven kelvins.

A further feature or aspect of an embodiment is believed at the time of the filing of this patent application to possibly reside broadly in the use of a polyurethane foam for the internal insulation of tanks for the storage of cryogenic fluids, in at least one possible embodiment of liquid hydrogen (LH₂), wherein it is deposited on the interior of the tank using the casting or spray method.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The following patents, patent applications or patent publications, are hereby incorporated by reference as if set forth in their entirety herein except for the exceptions indicated herein: FR 27 87 796 B1, having the translated English title “Polyurethane foam for use as insulating material at ultra-low temperatures is prepared by reacting polyether polyol mixture with 4,4′-diphenylmethane diisocyanate polymer,” published on Jun. 30, 2000; KR 1020000010023 A, having the translated English title “POLYURETHANE FOAM FOR ULTRA-LOW-TEMPERATURE INSULATION, THE PROCESS FOR PRODUCING IT, AND INSULATING MATERIAL BY USING IT,” published on Feb. 15, 2000; JP 2000063477 A, having the translated English title “THERMAL SPRAY COATED MEMBER EXCELLENT IN CORROSION RESISTANCE, AND ITS MANUFACTURING METHOD,” published on Sep. 14, 2001; and U.S. Pat. No. 3,895,146 A, having the title “Method and structure for thermally insulating low temperature liquid storage tanks,” published on Jul. 15, 1975.

The patents, patent applications, and patent publications listed above in the preceding paragraphs are herein incorporated by reference as if set forth in their entirety except for the exceptions indicated herein. The purpose of incorporating U.S. patents, Foreign patents, publications, etc. is solely to provide additional information relating to technical features of one or more embodiments, which information may not be completely disclosed in the wording in the pages of this application. However, words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, and patent publications, are not considered to be incorporated by reference herein.

The corresponding foreign patent publication application, namely, Federal Republic of Germany Patent Application No. 10 2009 016 632.7, filed on Apr. 1, 2009, having inventors Jörg KRÜGER, Mark MÜLLER, Vladimir YAKUSHIN, Ugis CABULIS, and Uldis STIRNA, and DE-OS 10 2009 016 632.7 and DE-PS 10 2009 016 632.7, are hereby incorporated by reference as if set forth in their entirety herein, except for the exceptions indicated herein, for the purpose of correcting and explaining any possible misinterpretations of the English translation thereof. In addition, the published equivalents of the above corresponding foreign patent publication application, and other equivalents or corresponding applications, if any, in corresponding cases in the Federal Republic of Germany and elsewhere, and the references and documents cited in any of the documents cited herein, such as the patents, patent applications and publications, except for the exceptions indicated herein, are hereby incorporated by reference as if set forth in their entirety herein.

The purpose of incorporating the corresponding foreign equivalent patent application, that is, DE 10 2009 016 632.7, is solely for the purpose of providing a basis of correction of any wording in the pages of the present application, which may have been mistranslated or misinterpreted by the translator. However, words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned word in this sentence, when not used to describe technical features of one or more embodiments of the patents, patent applications, and patent publications, are not generally considered to be incorporated by reference herein.

Statements made in the original foreign patent application DE 10 2009 016 632.7 from which this patent application claims priority which do not have to do with the correction of the translation in this patent application are not to be included in this patent application in the incorporation by reference.

Any statements about admissions of prior art in the original foreign patent application DE 10 2009 016 632.7 are not to be included in this patent application in the incorporation by reference, since the laws relating to prior art in non-U.S. Patent Offices and courts may be substantially different from the Patent Laws of the United States.

All of the references and documents cited in any of the documents cited herein, except for the exceptions indicated herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A polyurethane foam for thermal insulation at extremely low temperatures, said polyurethane foam comprising polyisocyanate and a polyol mixture, wherein said polyol mixture comprises at least two active hydrogen atoms, a chain extender, a blowing agent, a foam stabilizer and catalysts, and wherein the proportion of urethane, ester, and aromatic rings in the polymer matrix of the polyurethane foam is between 70 and 85 wt. %, and the molecular weight per branching unit is between 500 and 700.

2. The polyurethane foam as recited in claim 1, wherein the polyol mixture comprises the following:
a) a polyether polyol;
b) 15 to 45 wt. % of a chain extender with the functionality 2.0;
c) 25 to 45 wt. % of an aromatic structure polyester polyol with an OH value between 200 and 280 mg KOH/g with the functionality 2.0, and
wherein the sum of the components of a), b) and c) is 100 wt. %.

3. The polyurethane foam as recited in claim 1, wherein the chain extender consists of C4 to C6 alkanediol, 1,4-butanediol, 2,3-butanediol, 1,5-pentanediol or 1,6-hexanediol.

4. The polyurethane foam as recited in claim 1, wherein the chain extender consists of diethylene glycol or dipropylene glycol.

5. The polyurethane foam as recited in claim 1, wherein the chain extender is an N-substituted diethanol amine: N-methyldiethanol amine, N-ethyldiethanol amine or N-phenyl diethanolamine.

6. The polyurethane foam as recited in claim 1, wherein the OH value is between 500 and 750.

7. The polyurethane foam as recited in claim 1, wherein the functionality of the basic polyisocyanate is between 2.1 and 2.9.

8. The polyurethane foam as recited in claim 1, wherein the polurethane foam is produced by a casting or spraying method and its density is in the range of 65 to 110 kg/m³, preferably 70 to 90 kg/m³, the ratio ε77/ΔI(296-77) of the elongation at failure in the vertical foaming direction at 77 K, ε677, to the contraction in the vertical foaming direction during cooling from 296 K to 77 K, ΔI(296-77), perpendicular to the foaming direction in the range of 3.5 to 5.0 and that its compressive strength parallel to the foaming direction is in the range of 0.65 to 0.90 MPa at 296 K and 1.5 to 2.1 MPa at 77 K.

9. Use of a polyurethane foam as recited in claim 8 for the internal insulation of tanks for the storage of cryogenic fluids, in particular of liquid hydrogen (LH₂), wherein the polyurethane foam is deposited on the interior of the tank using the casting or spray method.

10. The polyurethane foam as recited in claim 2, wherein the chain extender consists of C4 to C6 alkanediol, 1,4-butanediol, 2,3-butanediol, 1,5-pentanediol or 1,6-hexanediol.

11. The polyurethane foam as recited in claim 10, wherein:
the OH value is between 500 and 750; and
the functionality of the basic polyisocyanate is between 2.1 and 2.9.

12. The polyurethane foam as recited in claim 11, wherein the polurethane foam is produced by a casting or spraying method and its density is in the range of 65 to 110 kg/m³, preferably 70 to 90 kg/m³, the ratio ε77/ΔI(296-77) of the elongation at failure in the vertical foaming direction at 77 K, ε77, to the contraction in the vertical foaming direction during cooling from 296 K to 77 K, ΔI(296-77), perpendicular to the foaming direction in the range of 3.5 to 5.0 and that its compressive strength parallel to the foaming direction is in the range of 0.65 to 0.90 MPa at 296 K and 1.5 to 2.1 MPa at 77 K.

13. Use of a polyurethane foam as recited in claim 12 for the internal insulation of tanks for the storage of cryogenic fluids, in particular of liquid hydrogen (LH₂), wherein the polyurethane foam is deposited on the interior of the tank using the casting or spray method.

14. The polyurethane foam as recited in claim 2, wherein the chain extender consists of diethylene glycol or dipropylene glycol.

15. The polyurethane foam as recited in claim 14, wherein:
the OH value is between 500 and 750; and
the functionality of the basic polyisocyanate is between 2.1 and 2.9.

16. The polyurethane foam as recited in claim 15, wherein the polurethane foam is produced by a casting or spraying method and its density is in the range of 65 to 110 kg/m³, preferably 70 to 90 kg/m³, the ratio ε77/ΔI(296-77) of the elongation at failure in the vertical foaming direction at 77 K, ε77, to the contraction in the vertical foaming direction during cooling from 296 K to 77 K, ΔI(296-77), perpendicular to the foaming direction in the range of 3.5 to 5.0 and that its compressive strength parallel to the foaming direction is in the range of 0.65 to 0.90 MPa at 296 K and 1.5 to 2.1 MPa at 77 K.

17. Use of a polyurethane foam as recited in claim 16 for the internal insulation of tanks for the storage of cryogenic fluids, in particular of liquid hydrogen (LH₂), wherein the polyurethane foam is deposited on the interior of the tank using the casting or spray method.

18. The polyurethane foam as recited in claim 2, wherein the chain extender is an N-substituted diethanol amine: N-methyldiethanol amine, N-ethyldiethanol amine or N-phenyl diethanolamine.

19. The polyurethane foam as recited in claim 18, wherein:
the OH value is between 500 and 750;
the functionality of the basic polyisocyanate is between 2.1 and 2.9; and
the polyurethane foam is produced by a casting or spraying method and its density is in the range of 65 to 110 kg/m³, preferably 70 to 90 kg/m³, the ratio ε77/ΔI(296-77) of the elongation at failure in the vertical foaming direction at 77 K, ε77, to the contraction in the vertical foaming direction during cooling from 296 K to 77 K, ΔI(296-77), perpendicular to the foaming direction in the range of 3.5 to 5.0 and that its compressive strength parallel to the foaming direction is in the range of 0.65 to 0.90 MPa at 296 K and 1.5 to 2.1 MPa at 77 K.

20. Use of a polyurethane foam as recited in claim 19 for the internal insulation of tanks for the storage of cryogenic fluids, in particular of liquid hydrogen (LH₂), wherein the polyurethane foam is deposited on the interior of the tank using the casting or spray method.
